(19) United States
(12) Patent Application Publication
(10) Pub. No.: US 2024/0127995 A1
(43) Pub. Date: Apr. 18, 2024

(54) R-T-B MAGNET AND PREPARATION METHOD THEREFOR

(71) Applicant: FUJIAN GOLDEN DRAGON RARE-EARTH Co., Ltd., Fujian (CN)

(72) Inventors: Weiguo MOU, Fujian (CN); Jiaying HUANG, Fujian (CN)

(73) Assignee: FUJIAN GOLDEN DRAGON RARE-EARTH Co., Ltd., Fujian (CN)

(21) Appl. No.: 18/277,116

(22) PCT Filed: Jan. 17, 2022
(86) PCT No.: PCT/CN2022/072251

§ 371 Date: Aug. 14, 2023

(30) Foreign Application Priority Data
Mar. 17, 2021 (CN) 202110287750.1

(51) Int. Cl. H01F 1/057; H01F 41/02

(52) U.S. Cl. CPC H01F 1/0577; H01F 41/0293

(57) ABSTRACT

An R-T-B magnet includes the following components of: ≥30.0 wt % of R, the R is a rare earth element; 0.02-0.14 wt % of Nb; 0.2-0.48 wt % of Cu; ≤0.24 wt % of Ti+Nb; ≤0.50 wt % of Al+Cu; ≥0.955 wt % of B; and 58-69 wt % of Fe, wherein wt % is the mass percentage of respective component in the total mass of all components. The R-T-B magnet has remanence, coercivity, high-temperature stability and squareness at a better level. A method prepares the R-T-B magnet.

### FIELD OF THE INVENTION

The invention relates to a R-T-B magnet and a preparation method thereof.

### BACKGROUND OF THE INVENTION

Neodymium-iron-boron magnet materials have been widely used in electronics, electrical machinery, medical appliances and other fields. In recent years, the improvement of the magnetic properties of the neodymium-iron-boron magnet materials has become a current research hotspot.

For example, Chinese patent document CN108831650A discloses a neodymium iron boron magnet material and a preparation method thereof. By adding 0.05-0.5% of each of titanium, zirconium, niobium, and gallium to the neodymium-iron-boron material and adopting the principle of adding a small amount of multiple types, the amount of heavy rare earth elements in the material is reduced. In addition, the secondary aging temperature of each grade can be unified, thereby improving the universality of secondary aging. The addition of these four composite elements can achieve the purpose of refining the grains while improving the fluidity of the rare earth-rich phase at the grain boundary, improving various performance indicators of the material, especially the intrinsic coercivity and squareness, and reducing the amount of heavy rare earth. At the same time, the squareness of the product is improved, and the consistency and high temperature stability of the product are improved. For example, the formula of Example 5 in this patent comprised the following components by mass of: 30.3% of PrNd, 0% of Dy, 0.97% of B, 0.5% of Co, 0.15% of Cu, 0.1% of Al, 0.08% of Ti, 0.1% of Nb, 0.2% of Ga, 0.05% of Zr, and Fe as the balance. A fine powder of 3.0 μm was prepared from the above components by a jet mill. A neodymium iron boron magnet material having a remanence of 14.4, a Hcj of 12.5, a maximum energy product of 50.82 and a squareness of 97% was obtained by a preparation process including a sintering temperature of 1040° C., a primary aging temperature of 900° C., and a secondary aging temperature of 520° C. However, the formulation of this magnet material was not further optimized. The coercivity of the obtained magnet material is at a low level, and the magnetic properties and temperature resistance thereof at high temperature are also at a lower level, which cannot be applied to products with higher requirements.

The technical problem that needs to be solved at present is to find a formula for neodymium iron boron magnets, and the magnet materials prepared by it have excellent comprehensive magnetic properties that is, high coercivity, high remanence, high temperature stability for coercivity, and high squareness.

### SUMMARY OF THE INVENTION

In order to remove the defect that the remanence, coercivity, high temperature stability and squareness of the magnets obtained according to the formula of the neodymium iron boron magnet material in the prior art cannot reach a higher level at the same time, the present invention provides a R-T-B magnet and a preparation method thereof. Through the combination of specific element types and specific contents in the R-T-B magnet of the present invention, the magnet materials with higher remanence, coercivity, squareness, and better high temperature stability can be prepared.

The present invention solves the above-mentioned technical problem mainly through the following technical solutions.

The invention provides a R-T-B magnet, comprising the following components of:
≥30.0 wt % of R, said R is a rare earth element;
0.02-0.14 wt % of Nb;
0.2-0.48 wt % of Cu;
≤0.24 wt % of Ti+Nb;
≤0.50 wt % of Al+Cu;
≥0.955 wt % of B; and
58-69 wt % of Fe, wherein

wt % is the mass percentage of respective component in the total mass of all components.

In the invention, the content of R is preferably 30-33 wt %, such as 30 wt %, 30.3 wt % or 30.8 wt %.

In the invention, the kinds of R can be traditional in the field, generally include Nd.

Wherein, the content of Nd is preferably 29-31 wt %, such as 29 wt %, 29.4 wt %, 29.7 wt %, 29.9 wt %, 30 wt %, 30.1 wt % or 30.4 wt %, wherein wt % is the mass percentage of Nd in the total mass of all components.

In the invention, the R generally further comprises Pr and/or RH, wherein the RH is a heavy rare earth element.

Wherein, the content of the Pr is preferably 0.3 wt % or less, wherein wt % is the mass percentage of Pr in the total mass of all components.

Wherein, the heavy rare earth element is preferably Tb.

Wherein the content of the RH can be 1.4 wt % or less, such as 0.2 wt %, 0.4 wt %, 0.6 wt % or 1 wt %, wherein wt % is the mass percentage of RH in the total mass of all components.

Wherein the ratio of the atomic percentage of the RH to the atomic percentage of the R can be 0.1 or less, such as 0.02, 0.04 or 0.06, wherein the atomic percentage is the atomic percentage in the total content of all components.

In the invention, the content of “Ti+Nb” is preferably 0.1-0.24 wt %, such as 0.1 wt %, 0.2 wt %, 0.23 wt % or 0.24 wt %.

In the invention, the content of Nb is preferably 0.05-0.14 wt %, such as 0.05 wt %, 0.09 wt %, 0.1 wt %, 0.12 wt % or 0.14 wt %.

In the invention, the content of Ti is preferably 0.24 wt % or less, excluding 0 wt %, such as 0.05 wt %, 0.09 wt %, 0.11 wt %, 0.14 wt % or 0.15 wt %.

In the invention, the content of “Al+Cu” is preferably 0.44 wt % or less, excluding 0 wt %, preferably 0.1-0.44 wt %, such as 0.23 wt %, 0.25 wt %, 0.32 wt %, 0.33 wt %, 0.34 wt % %, 0.43 wt %, 0.44 wt % or 0.45 wt %.

In the invention, the content of Al is preferably 0.08 wt % or less, excluding 0 wt %, such as 0.02 wt %, 0.03 wt %, 0.04 wt %, 0.05 wt %, 0.06 wt % or 0.08 wt %.

In the invention, the content of Cu is preferably 0.2-0.46 wt %, such as 0.2 wt %, 0.3 wt %, 0.39 wt %, 0.4 wt % or 0.46 wt %.

In the invention, the content of B is preferably 0.955-1.15 wt %, such as 0.99 wt %.

In the invention, the ratio of the atomic percentage of B to the atomic percentage of R in the R-T-B magnet can be 0.38 or more, such as 0.4, 0.41, 0.42, 0.43 or 0.44, wherein the atomic percentage is the atomic percentage in the total content of all components.

In the invention, the content of Fe is 67-69 wt %, such as 67.53 wt %, 67.58 wt %, 67.63 wt %, 67.68 wt %, 67.74 wt %, 68.02 wt %, 68.03 wt %, 68.04 wt %, 68.16 wt %, 68.31 wt %, 68.38 wt %, 68.49 wt %, 68.57 wt % % or 68.58 wt %.

In the present invention, the R-T-B magnet may further comprise the conventional additive elements in the field, such as Co.

Wherein the content of Co is 1 wt % or less, such as 0.8 wt %, wherein wt % is the mass percentage of respective component in the total mass of all components.

Those skilled in the art know that in the present invention, unavoidable impurities, such as one or more of C, O and Mn, are generally introduced during the preparation of the R-T-B magnet.

By optimizing the formula of the R-T-B magnet, the inventor found that the combination of the above-mentioned specific contents of Ti, Nb, Cu and other elements can make the obtained R-T-B magnets achieve significant improvement in terms of the magnetic properties such as coercivity, high-temperature stability and squareness. Through further analysis, it is found that after the R-T-B magnet is prepared, the components of the above specific formula make a part of Fe in the two-grain boundary phase gather with Nb and Cu elements to form a Cu—Nb—Fe phase. The presence of the Cu—Nb—Fe phase significantly reduces the content of Fe in the two-grain boundary phase, increases the magnetic isolation effect of the Nd-rich phase, and thus obtains the R-T-B magnet of the present invention.

In the present invention, the R-T-B magnet comprises a Cu—Nb—Fe phase. The Cu—Nb—Fe phase is located in the intergranular triangular region. The intergranular triangular region can have the meaning commonly understood in the art, and generally refers to the grain boundary phase formed among more than three main phase particles. The grain boundary phase is generally a general term for the region formed by a two-grain boundary phase and an intergranular triangular region. The two-grain boundary phase is generally the grain boundary phase between two main phase particles.

Wherein, in the intergranular triangular region, the ratio of the area of the Cu—Nb—Fe phase to the total area of the intergranular triangular region is 1.3-2%, such as 1.3%, 1.4%, 1.5% or 1.6%. In the present invention, the area of the Cu—Nb—Fe phase or the total area of the intergranular triangular region generally refers to the area thereof occupied in the cross-section of the detected R-T-B magnet during FE-EPMA detection.

Wherein the ratio of the content of Fe in the two-grain boundary phase to the total content of all elements in the two-grain boundary phase is 46 wt % or less, such as 40 wt %, 41 wt %, 42 wt %, 43 wt %, 44 wt %, 45 wt %, or 46 wt %. Said all elements in the two-grain boundary phase are, for example, Fe, rare earth elements, Cu, and Nb or the like.

Wherein, it is detected that in the Cu—Nb—Fe phase, the ratio of Cu, Nb and Fe in atomic percentage is close to 5:1:94. Therefore, in the present invention, the Cu—Nb—Fe phase is a Cu₅Nb₁Fe₉₄ phase.

In a preferable example of the invention, the R-T-B magnet comprises the following components of: 29.4 wt % of Nd, 0.6 wt % of Th, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 45 wt %.

In a preferable example of the invention, the R-T-B magnet comprises the following components of: 29.4 wt % of Nd, 0.6 wt % of Tb, 0.8 wt % of Co, 0.3 wt % of Cu, 0.03 wt % of Al, 0.05 wt % of Nb, 0.15 wt % of Ti, 0.99 wt % of B and 67.68 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 46 wt %.

In a preferable example of the invention, the R-T-B magnet comprises the following components of: 29.4 wt % of Nd, 0.6 wt % of Tb, 0.5 wt % of Co, 0.2 wt % of Cu, 0.05 wt % of Al, 0.05 wt % of Nb, 0.05 wt % of Ti, 0.99 wt % of B and 68.16 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %.

In a preferable example of the invention, the R-T-B magnet comprises the following components of: 29.4 wt % of Nd, 0.6 wt % of Tb, 0.6 wt % of Co, 0.4 wt % of Cu, 0.04 wt % of Al, 0.14 wt % of Nb, 0.09 wt % of Ti, 0.99 wt % of B and 67.74 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.6%, and the ratio of the content of Fe in a two-grain boundary phase to the total content of all elements in the two-grain boundary phase is 43 wt %.

In a preferable example of the invention, the R-T-B magnet comprises the following components of: 29.4 wt % of Nd, 0.6 wt % of Th, 0.2 wt % of Cu, 0.03 wt % of Al, 0.05 wt % of Nb, 0.15 wt % of Ti, 0.99 wt % of B and 68.58 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 43 wt %.

In a preferable example of the invention, the R-T-B magnet comprises the following components of: Nd 29.4 wt %, 0.6 wt % of Th, 0.39 wt % of Cu, 0.04 wt % of Al, 0.05 wt % of Nb, 0.15 wt % of Ti, 0.99 wt % of B and 68.38 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 42 wt %.

In a preferable example of the invention, the R-T-B magnet comprises the following components of: 29.4 wt % of Nd, 0.6 wt % of Tb, 0.46 wt % of Cu, 0.04 wt % of Al, 0.05 wt % of Nb, 0.15 wt % of Ti, 0.99 wt % of B and 68.31 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 46 wt %.

In a preferable example of the invention, the R-T-B magnet comprises the following components of: 29.4 wt % of Nd, 0.6 wt % of Tb, 0.3 wt % of Cu, 0.04 wt % of Al, 0.05 wt % of Nb, 0.05 wt % of Ti, 0.99 wt % of B and 68.57 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 44 wt %.

In a preferable example of the invention, the R-T-B magnet comprises the following components of: 29.4 wt % of Nd, 0.6 wt % of Tb, 0.8 wt % of Co, 0.3 wt % of Cu, 0.03 wt % of Al, 0.1 wt % of Nb, 0.14 wt % of Ti, 0.99 wt % of B and 67.64 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 43 wt %.

In a preferable example of the invention, the R-T-B magnet comprises the following components of: 29.4 wt % of Nd, 0.6 wt % of Tb, 0.8 wt % of Co, 0.3 wt % of Cu, 0.03 wt % of Al, 0.12 wt % of Nb, 0.11 wt % of Ti, 0.99 wt % of B and 67.65 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %.

In a preferable example of the invention, the R-T-B magnet comprises the following components of: 29.7 wt % of Nd, 0.6 wt % of Th, 0.39 wt % of Cu, 0.04 wt % of Al, 0.1 wt % of Nb, 0.14 wt % of Ti, 0.99 wt % of B and 68.04 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.6%, and the ratio of the content of Fe in a two-grain boundary phase to the total content of all elements in the two-grain boundary phase is 45 wt %.

In a preferable example of the invention, the R-T-B magnet comprises the following components of: 30.4 wt % of Nd, 0.4 wt % of Th, 0.39 wt % of Cu, 0.05 wt % of Al, 0.1 wt % of Nb, 0.14 wt % of Ti, 0.99 wt % of B and 67.53 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %.

In a preferable example of the invention, the R-T-B magnet comprises the following components of: 29.9 wt % of Nd, 0.4 wt % of Tb, 0.39 wt % of Cu, 0.06 wt % of Al, 0.1 wt % of Nb, 0.14 wt % of Ti, 0.99 wt % of B and 68.02 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 43 wt %.

In a preferable example of the invention, the R-T-B magnet comprises the following components of: 30.1 wt % of Nd, 0.2 wt % of Th, 0.39 wt % of Cu, 0.05 wt % of Al, 0.09 wt % of Nb, 0.15 wt % of Ti, 0.99 wt % of B and 68.03 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 44 wt %.

In a preferable example of the invention, the R-T-B magnet comprises the following components of: 29.4 wt % of Nd, 0.6 wt % of Tb, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 42 wt %.

In a preferable example of the invention, the R-T-B magnet comprises the following components of: 29.4 wt % of Nd, 0.6 wt % of Tb, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 45 wt %.

In a preferable example of the invention, the R-T-B magnet comprises the following components of: 30 wt % of Nd, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 43 wt %.

In a preferable example of the invention, the R-T-B magnet comprises the following components of: 29 wt % of Nd, 1 wt % of Tb, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %.

In a preferable example of the invention, the R-T-B magnet comprises the following components of: 28.2 wt % of Nd, 0.6 wt % of Tb, 1.2 wt % of Dy, 0.36 wt % of Cu, 0.02 wt % of Al, 0.05 wt % of Nb, 0.15 wt % of Ti, 0.99 wt % of B and 68.43 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 44 wt %.

In a preferable example of the invention, the R-T-B magnet comprises the following components of: 28.4 wt % of Nd, 0.6 wt % of Tb, 1 wt % of Dy, 0.5 wt % of Co, 0.36 wt % of Cu, 0.02 wt % of Al, 0.05 wt % of Nb, 0.15 wt % of Ti, 0.99 wt % of B and 67.93 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.3%, and the ratio of the content of Fe in a two-grain boundary phase to the total content of all elements in the two-grain boundary phase is 46 wt %.

In a preferable example of the invention, the R-T-B magnet comprises the following components of: 28.8 wt % of Nd, 0.6 wt % of Tb, 0.6 wt % of Dy, 0.36 wt % of Cu, 0.02 wt % of Al, 0.05 wt % of Nb, 0.15 wt % of Ti, 0.99 wt % of B and 68.43 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.3%, and the ratio of the content of Fe in a two-grain boundary phase to the total content of all elements in the two-grain boundary phase is 46 wt %.

In a preferable example of the invention, the R-T-B magnet comprises the following components of: 28.2 wt % of Nd, 0.7 wt % of Tb, 0.3 wt % of Dy, 0.8 wt % of Co, 0.36 wt % of Cu, 0.02 wt % of Al, 0.05 wt % of Nb, 0.15 wt % of Ti, 0.99 wt % of B and 68.43 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.3%, and the ratio of the content of Fe in a two-grain boundary phase to the total content of all elements in the two-grain boundary phase is 46 wt %.

The invention further provides a preparation method of the R-T-B magnet as described above, comprising the steps of subjecting a raw mixture comprising respective components as described above to pulverization and then sintering treatment, wherein the particle size of the powder obtained after the pulverization is 3.9-4.4 μm.

In the invention, the particle size of the powder obtained after the pulverization is, for example, 3.9 μm, 4.0 μm, 4.1 μm, 4.2 μm or 4.3 μm.

In the present invention, in the process of preparing the R-T-B magnet, the inventors found that if the particle size of the powder after the pulverization is greater than 4.4 μm or less than 3.9 μm, the area fraction of Cu—Nb—Fe phase in the intergranular triangular region in the R-T-B magnet will be reduced.

In the present invention, the pulverization process can be the conventional technology in the field, such as jet mill pulverization.

Wherein, the gas atmosphere during the pulverization can be a gas atmosphere with an oxidizing gas content of 1000 ppm or less, and the oxidizing gas content refers to the content of oxygen or moisture.

Wherein, the pressure during the pulverization is, for example, 0.68 MPa.

Wherein, after the pulverization, a lubricant such as zinc stearate is generally added.

Wherein, the added amount of the lubricant may be 0.05-0.15%, such as 0.12%, of the mass of the powder obtained after the pulverization.

In the present invention, the temperature for the sintering treatment can be a conventional temperature in the field, 1000-1100° C., for example 1080° C.

In the present invention, the sintering treatment is carried out under a vacuum condition, such as a vacuum condition of 5×10⁻³ Pa.

In the present invention, the time for the sintering treatment can be conventional in the field, and can be 4-8 hours, for example, 6 hours.

In the invention, as known by those skilled in the field, the preparation method further comprises the steps of subjecting a raw mixture comprising respective components for the R-T-B magnet to smelting, casting and hydrogen decrepitation in turn before the pulverization.

Wherein, the smelting can be a conventional smelting process in the art.

The vacuum degree for the smelting is, for example, 5×10⁻² Pa.

The temperature for the smelting is, for example, 1550° C. or less.

The smelting is generally carried out in a high-frequency vacuum induction melting furnace.

Wherein, the casting process can be conventional techniques in the field.

Wherein, the process for the casting is, for example, a strip casting process.

Wherein, the temperature for the casting can be 1390-1460° C., such as 1400° C., 1420° C. or 1430° C.

Wherein, the alloy sheet obtained after the casting can have a thickness of 0.25-0.40 mm, such as 0.29 mm.

Wherein, the process of hydrogen decrepitation can generally comprise hydrogen absorption, dehydrogenation, and cooling treatment in turn.

The hydrogen absorption can be carried out under the condition of hydrogen pressure of 0.085 MPa.

The dehydrogenation can be carried out under the condition of raising the temperature while evacuating. The dehydrogenation temperature may be 480-520° C., such as 500° C.

In the present invention, after the pulverization and before the sintering treatment, a conventional shaping process in the field is generally included.

Wherein, the shaping can be a magnetic field shaping method.

Wherein, the shaping is carried out under the protection of a nitrogen atmosphere with a magnetic field strength of 1.8 T or more. For example, it is carried out under the magnetic field strength of 1.8-2.5 T.

In the present invention, a conventional aging treatment in the art is generally included after the sintering treatment.

Wherein, the aging treatment generally includes a primary aging and a secondary aging.

The temperature for the primary aging treatment may be 860-920° C., such as 880° C. or 900° C.

The time for the primary aging treatment may be 2.5-4 hours, such as 3 hours.

The temperature for the secondary aging treatment may be 460-530° C., such as 490° C., 500° C., 510° C. or 520° C.

The time for the secondary aging treatment may be 2.5-4 hours, such as 3 hours.

In the present invention, when the R-T-B magnet further comprises heavy rare earth elements, the preparation method generally comprises grain boundary diffusion after the aging treatment.

Wherein, the grain boundary diffusion can be a conventional process in the field, and generally the heavy rare earth elements are diffused at the grain boundary.

The temperature for the grain boundary diffusion may be 800-900° C., such as 850° C.

The time for the grain boundary diffusion may be 5-10 hours, such as 8 hours.

Wherein, the method of adding heavy rare earth elements to the R-T-B magnet can be carried out by referring to conventional techniques in the art. Generally, 0-80% of heavy rare earth elements are added during smelting and the rest are added during smelting, such as 33%, 38%, 40%, 57% or 67%. The heavy rare earth element added during smelting is, for example, Tb.

For example, when the heavy rare earth elements in the R-T-B magnet are Tb with a content of greater than 0.5 wt %, 40-67% of Tb is added during the smelting, and the rest is added during the grain boundary diffusion. For example, when the heavy rare earth elements in the R-T-B magnet are Tb and Dy, the Tb is added during smelting, and the Dy is added during the grain boundary diffusion. For example, when the heavy rare earth elements in the R-T-B magnet are Tb with a content of less than or equal to 0.5 wt %, or when the heavy rare earth elements in the R-T-B magnet are Dy, the heavy rare earth elements in the R-T-B magnet are added during the grain boundary diffusion.

In the present invention, when the R-T-B magnet comprises less than 0.08 wt % of Al, generally no additional Al is added when preparing the raw material mixture of components.

Those skilled in the art know that Al below 0.08 wt % is generally introduced during the preparation process.

The present invention further provides an R-T-B magnet prepared by the above preparation method.

On the basis of conforming to common knowledge in the field, the above-mentioned preferred conditions can be combined arbitrarily to obtain the preferred examples of the present invention.

The reagents and raw materials used in the present invention are all commercially available.

The positive progress effects of the present invention are as follows:

Through the combination of the specific contents of Ti, Nb, Cu and other elements, the present invention further optimizes the formula of the R-T-B magnet so that the obtained R-T-B magnet is significantly improved in coercivity, and the magnetic properties thereof such as remanence, high-temperature stability and squareness are simultaneously at a higher level.

### BRIEF DESCRIPTION OF THE DRAWINGS

FIG. 1 shows the SEM image of the R-T-B magnet in Example 1, wherein the arrow a in FIG. 1 points to the Cu—Nb—Fe phase in the intergranular triangular region by the single-point quantitative analysis.

### DETAILED DESCRIPTION OF THE INVENTION

The present invention is further illustrated below by means of examples, but the present invention is not limited to the scope of the examples. The experimental methods not indicating specific conditions in the following examples were carried out according to conventional methods and conditions, or were selected according to the product instructions.

### Example 1

The raw materials were prepared according to the ingredients of the R-T-B magnet of Example 1 shown in Table 1 below to obtain a raw material mixture. The raw material mixture (For Tb in Table 1, 0.4 wt % thereof was added in smelting, and the remaining 0.2 wt % was added in grain boundary diffusion described below) was sequentially subjected to smelting, casting, hydrogen decrepitation, pulverization, magnetic field shaping, sintering, aging treatment and grain boundary diffusion.

Wherein, the smelting was carried out in a high-frequency vacuum induction melting furnace, wherein the vacuum degree of the melting furnace was 5×10⁻² Pa, and the temperature was 1530° C. or less;

The casting was carried out by the strip casting process to obtain an alloy sheet with a thickness of 0.29 mm, wherein the casting temperature was 1420° C.;

The hydrogen decrepitation included hydrogen absorption, dehydrogenation, and cooling in sequence. The hydrogen absorption can be carried out under the condition of hydrogen pressure of 0.085 MPa; the dehydrogenation can be carried out under the condition of heating up while vacuuming, and the dehydrogenation temperature was 500° C.;

The pulverization included jet mill pulverization in an atmosphere having an oxidizing gas content of 100 ppm or less. The particle size of the obtained powder was 4.1 μm. The oxidizing gas refers to oxygen or moisture content. The pressure in the grinding chamber of the jet mill was 0.68 MPa. After pulverizing, a lubricant, that is, zinc stearate, was added and the addition amount thereof was 0.12% by weight of the powder after mixing;

The magnetic field shaping was carried out under the protection of a nitrogen atmosphere with a magnetic field strength of 1.8-2.5 T;

The sintering includes sintering under a vacuum condition of 5×10⁻³ Pa and 1080° C. for 6h, and then cooling. Before cooling, Ar gas can be introduced to make the pressure reach 0.05 MPa;

Aging treatment: the temperature for the primary aging was 900° C., and the time for the primary aging was 3h; the temperature for the secondary aging was 490° C., and the time for the secondary aging was 3h.

Grain boundary diffusion: the remaining heavy rare earth elements (0.2 wt % Tb) were attached on the surface of the material, and grain boundary diffusion was carried out at 850° C. for 8h.

2. The raw materials and powder particle sizes of the R-T-B magnets of Examples 2-22 and Comparative Examples 1-7 are shown in Table 1 below, and the rest preparation processes thereof are the same as that of Example 1. Among them, in Examples 1-11, 15, 16, 18 and Comparative Examples 1-7, 0.4 wt % f Tb was added during smelting, and the remaining Tb was diffused into the R-T-B magnets during grain boundary diffusion. In Examples 12-14, the heavy rare earth elements were added during grain boundary diffusion. Example 17 did not include the process of grain boundary diffusion. In Examples 19-22, Tb was added during melting, and Dy was added during grain boundary diffusion.

### Effect Example 1

1. Determination of Components:

The R-T-B permanent magnet materials prepared in Examples 1-22 and Comparative Examples 1-7 were measured using a high-frequency inductively coupled plasma optical emission spectrometer (ICP-OES). The test results are shown in Table 1 below.

TABLE 1
Table 1 Components and contents (wt %) of the R-T-B magnets

| | | | | | | | | | | | Particle | | |
|---|---|---|---|---|---|---|---|---|---|---|---|---|---|
| | | | | | | | | | | | Size of | | |
| | Nd | Tb | Dy | Co | Cu | Al | Nb | Ti | B | Fe | powder(μm) | Ti + Nb | Al + Cu |
| Example 1 | 29.4 | 0.6 | / | / | 0.3 | 0.02 | 0.05 | 0.15 | 0.99 | 68.49 | 4.1 | 0.2 | 0.32 |
| Example 2 | 29.4 | 0.6 | / | 0.8 | 0.3 | 0.03 | 0.05 | 0.15 | 0.99 | 67.68 | 4.2 | 0.2 | 0.33 |
| Example 3 | 29.4 | 0.6 | / | 0.5 | 0.2 | 0.05 | 0.05 | 0.05 | 0.99 | 68.16 | 4.1 | 0.1 | 0.25 |
| Example 4 | 29.4 | 0.6 | / | 0.6 | 0.4 | 0.04 | 0.14 | 0.09 | 0.99 | 67.74 | 4.1 | 0.23 | 0.44 |
| Example 5 | 29.4 | 0.6 | / | / | 0.2 | 0.03 | 0.05 | 0.15 | 0.99 | 68.58 | 4 | 0.2 | 0.23 |
| Example 6 | 29.4 | 0.6 | / | / | 0.39 | 0.04 | 0.05 | 0.15 | 0.99 | 68.38 | 3.9 | 0.2 | 0.43 |
| Example 7 | 29.4 | 0.6 | / | / | 0.46 | 0.04 | 0.05 | 0.15 | 0.99 | 68.31 | 3.9 | 0.2 | 0.5 |
| Example 8 | 29.4 | 0.6 | / | / | 0.3 | 0.04 | 0.05 | 0.05 | 0.99 | 68.57 | 4.3 | 0.1 | 0.34 |
| Example 9 | 29.4 | 0.6 | / | 0.8 | 0.3 | 0.03 | 0.1 | 0.14 | 0.99 | 67.64 | 4.2 | 0.24 | 0.33 |
| Example 10 | 29.4 | 0.6 | / | 0.8 | 0.3 | 0.03 | 0.12 | 0.11 | 0.99 | 67.65 | 4.2 | 0.23 | 0.33 |
| Example 11 | 29.7 | 0.6 | / | / | 0.39 | 0.04 | 0.1 | 0.14 | 0.99 | 68.04 | 4.2 | 0.24 | 0.43 |
| Example 12 | 30.4 | 0.4 | / | / | 0.39 | 0.05 | 0.1 | 0.14 | 0.99 | 67.53 | 4.1 | 0.24 | 0.44 |
| Example 13 | 29.9 | 0.4 | / | / | 0.39 | 0.06 | 0.1 | 0.14 | 0.99 | 68.02 | 4.1 | 0.24 | 0.45 |
| Example 14 | 30.1 | 0.2 | / | / | 0.39 | 0.05 | 0.09 | 0.15 | 0.99 | 68.03 | 4.2 | 0.24 | 0.44 |
| Example 15 | 29.4 | 0.6 | / | / | 0.3 | 0.02 | 0.05 | 0.15 | 0.99 | 68.49 | 4 | 0.2 | 0.32 |
| Example 16 | 29.4 | 0.6 | / | / | 0.3 | 0.02 | 0.05 | 0.15 | 0.99 | 68.49 | 4.2 | 0.2 | 0.32 |
| Example 17 | 30 | / | / | / | 0.3 | 0.02 | 0.05 | 0.15 | 0.99 | 68.49 | 4.1 | 0.2 | 0.32 |
| Example 18 | 29 | 1 | / | / | 0.3 | 0.02 | 0.05 | 0.15 | 0.99 | 68.49 | 4.1 | 0.2 | 0.32 |
| Example 19 | 28.2 | 0.6 | 1.2 | / | 0.36 | 0.02 | 0.05 | 0.15 | 0.99 | 68.43 | 4.1 | 0.2 | 0.38 |
| Example 20 | 28.4 | 0.6 | 1 | 0.5 | 0.36 | 0.02 | 0.05 | 0.15 | 0.99 | 67.93 | 4.1 | 0.2 | 0.38 |
| Example 21 | 28.8 | 0.6 | 0.6 | / | 0.36 | 0.02 | 0.05 | 0.15 | 0.99 | 68.43 | 4.1 | 0.2 | 0.38 |
| Example 22 | 28.2 | 0.7 | 0.3 | 0.8 | 0.36 | 0.02 | 0.05 | 0.15 | 0.99 | 68.43 | 4.1 | 0.2 | 0.38 |
| Comparative | 29.4 | 0.6 | / | / | 0.1 | 0.03 | 0.05 | 0.15 | 0.99 | 68.68 | 4.1 | 0.2 | 0.13 |
| Example 1 | | | | | | | | | | | | | |
| Comparative | 29.4 | 0.6 | / | / | 0.3 | 0.4 | 0.04 | 0.04 | 0.99 | 68.23 | 3.9 | 0.08 | 0.7 |
| Example 2 | | | | | | | | | | | | | |
| Comparative | 29.4 | 0.6 | / | / | 0.3 | 0.3 | / | 0.08 | 0.99 | 68.33 | 4.1 | 0.08 | 0.6 |
| Example 3 | | | | | | | | | | | | | |
| Comparative | 29.4 | 0.6 | / | / | 0.5 | 0.02 | 0.05 | 0.15 | 0.99 | 68.29 | 4 | 0.2 | 0.52 |
| Example 4 | | | | | | | | | | | | | |
| Comparative | 29.4 | 0.6 | / | / | 0.3 | / | 0.2 | 0.15 | 0.99 | 68.36 | 4.1 | 0.35 | 0.3 |
| Example 5 | | | | | | | | | | | | | |
| Comparative | 29.4 | 0.6 | / | / | 0.3 | 0.02 | 0.05 | 0.15 | 0.99 | 68.49 | 3.8 | 0.2 | 0.32 |
| Example 6 | | | | | | | | | | | | | |
| Comparative | 29.4 | 0.6 | / | / | 0.3 | 0.02 | 0.05 | 0.15 | 0.99 | 68.49 | 4.5 | 0.2 | 0.32 |
| Example 7 | | | | | | | | | | | | | |

Note:
/ indicates that the element is not detected. Ga and Zr were not detected in the R-T-B magnets of the above-mentioned Examples and Comparative Examples. C, O, and Mn were inevitably introduced into the R-T-B magnet of the final product during the preparation process. The contents described in the respective Examples and Comparative Examples do not include these impurities. Additionally, Al having a content of below 0.08 wt % was introduced during the preparation process and was not specially added in the form of a raw material.

2. Testing for Magnetic Performance

The R-T-B magnets in Examples 1-22 and Comparative Examples 1-7 were tested by using a PFM pulsed BH demagnetization curve testing equipment to obtain the data of remanence (Br), intrinsic coercivity (Hcj), maximum energy product (BHmax) and squareness (Hk/Hcj). The testing results are shown in Table 2 below.

TABLE 2

| | 20° C. | 20° C. | | 20° C. | 150° C. | | 20−150° C. Hcj |
|---|---|---|---|---|---|---|---|
| | Br | Hcj | 20° C. | BHmax | Hcj | 150° C. | Temperature |
| | (kGs) | (kOe) | Hk/Hcj | (MGOe) | (kOe) | Hk/Hcj | Coefficient (%) |
| Example 1 | 14.35 | 24.4 | 0.99 | 49.98 | 10.18 | 0.99 | −0.45 |
| Example 2 | 14.35 | 24.5 | 0.99 | 49.98 | 10.23 | 0.99 | −0.45 |
| Example 3 | 14.36 | 24.1 | 0.99 | 50.05 | 10.01 | 0.99 | −0.45 |
| Example 4 | 14.34 | 25 | 0.99 | 49.91 | 10.5 | 0.99 | −0.45 |
| Example 5 | 14.32 | 24.3 | 0.98 | 49.77 | 10.12 | 0.98 | −0.45 |
| Example 6 | 14.31 | 25 | 0.99 | 49.7 | 10.28 | 0.99 | −0.45 |
| Example 7 | 14.3 | 24.7 | 0.99 | 49.63 | 10.34 | 0.99 | −0.45 |
| Example 8 | 14.38 | 24.2 | 0.99 | 50.19 | 10.07 | 0.98 | −0.45 |
| Example 9 | 14.36 | 24.5 | 0.99 | 50.05 | 10.23 | 0.99 | −0.45 |
| Example 10 | 14.34 | 24.7 | 0.99 | 49.91 | 10.34 | 0.99 | −0.45 |
| Example 11 | 14.33 | 24.4 | 0.99 | 49.84 | 10.18 | 0.98 | −0.45 |
| Example 12 | 14.3 | 23.7 | 0.99 | 49.63 | 9.56 | 0.99 | −0.46 |
| Example 13 | 14.36 | 23.5 | 0.99 | 50.05 | 9.46 | 0.99 | −0.46 |
| Example 14 | 14.38 | 22.8 | 0.99 | 50.19 | 9.13 | 0.99 | −0.46 |
| Example 15 | 14.34 | 24.6 | 0.99 | 49.91 | 10.28 | 0.99 | −0.45 |
| Example 16 | 14.36 | 24.2 | 0.99 | 50.05 | 10.07 | 0.99 | −0.45 |
| Example 17 | 14.45 | 21.5 | 0.99 | 50.68 | 8.97 | 0.99 | −0.45 |
| Example 18 | 14.32 | 26 | 0.99 | 49.77 | 10.8 | 0.99 | −0.45 |
| Example 19 | 14.26 | 25.6 | 0.99 | 48.42 | 10.56 | 0.99 | −0.45 |
| Example 20 | 14.32 | 25.13 | 0.99 | 48.82 | 10.35 | 0.99 | −0.45 |
| Example 21 | 14.43 | 24.12 | 0.99 | 49.58 | 9.92 | 0.99 | −0.45 |
| Example 22 | 14.48 | 23.78 | 0.99 | 49.92 | 9.75 | 0.99 | −0.45 |
| Comparative | 14.35 | 23.5 | 0.99 | 49.98 | 9.05 | 0.99 | −0.47 |
| Example 1 | | | | | | | |
| Comparative | 14.34 | 23.3 | 0.99 | 49.91 | 9.43 | 0.99 | −0.46 |
| Example 2 | | | | | | | |
| Comparative | 14.29 | 23.5 | 0.99 | 49.56 | 9.2 | 0.99 | −0.47 |
| Example 3 | | | | | | | |
| Comparative | 14.25 | 23.6 | 0.94 | 49.29 | 9.21 | 0.88 | −0.47 |
| Example 4 | | | | | | | |
| Comparative | 14.3 | 23.5 | 0.95 | 49.63 | 9.28 | 0.89 | −0.47 |
| Example 5 | | | | | | | |
| Comparative | 14.33 | 23.7 | 0.97 | 49.84 | 9.24 | 0.96 | −0.47 |
| Example 6 | | | | | | | |
| Comparative | 14.34 | 23.4 | 0.99 | 49.91 | 9.16 | 0.99 | −0.47 |
| Example 7 | | | | | | | |

3. Testing for Microstructures

FE-EPMA Detection:

The vertically oriented faces of the R-T-B magnets in Examples 1-22 and Comparative Examples 1-7 were polished, and tested by using a Field Emission Electron Probe Microanalyzer (FE-EPMA) (JEOL, 8530F). Firstly, the distribution of Cu, Nb, Fe and other elements in the R-T-B magnets was determined by surface scanning using FE-EPMA.

Then, the contents of Cu, Nb, Fe and other elements in the Cu—Nb—Fe phase were determined by single-point quantitative analysis using FE-EPMA. The test conditions included an accelerating voltage of 15 kv and a probe beam current of 50 nA. It can be seen from the test that the atomic ratios of Cu, Nb and Fe elements in the Cu—Nb—Fe phases in Examples 1-18 were close to 5:1:94, therefore, the Cu—Nb—Fe phase was a Cu₅Nb₁Fe₉₄ phase.

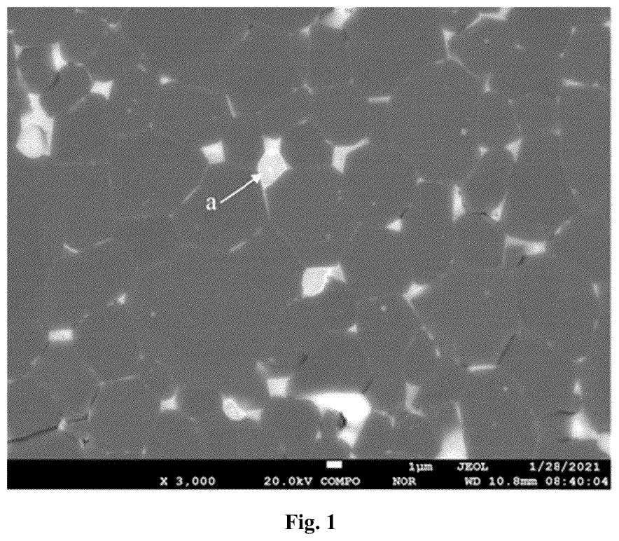

FIG. 1 shows the SEM image of the R-T-B magnet prepared in Example 1 detected by FE-EPMA. The arrow a of in FIG. 1 points to the Cu—Nb—Fe phase in the intergranular triangular region during the single-point quantitative analysis. It can be concluded through detection and calculation that a Cu₅Nb₁Fe₉₄ phase was formed in the intergranular triangular region in the R-T-B magnet of the present invention. In addition, the ratio of the area of the Cu₅Nb₁Fe₉₄ phase to the total area of the intergranular triangular region was 1.5%. The area of the Cu₅Nb₁Fe₉₄ phase and the total area of the intergranular triangular region respectively refer to the area thereof occupied in the cross-section (that is, the vertically oriented face as mentioned above) of the detected R-T-B magnet during FE-EPMA detection. In addition, the content of Fe in the two-grain boundary phase was analyzed by FE-EPMA detection. It can be seen that the ratio of the content of Fe in the two-grain boundary phase to the total content of all elements in the two-grain boundary phase was 45 wt %.

The testing results of FE-EPMA for the R-T-B magnets prepared in Examples 1-22 and Comparative Examples 1-7 are shown in Table 3 below.

TABLE 3

| | | Area | Fe Content in |
|---|---|---|---|
| | Whether | Percentage | Two-Grain |
| | Cu₅Nb₁Fe₉₄ | of Cu₅Nb₁Fe₉₄ | Boundary |
| | Phase Is | Phase | Phase |
| | Formed | (%) | (wt %) |
| Example 1 | Yes | 1.5 | 45% |
| Example 2 | Yes | 1.5 | 46% |
| Example 3 | Yes | 1.4 | 45% |
| Example 4 | Yes | 1.6 | 43% |
| Example 5 | Yes | 1.5 | 43% |
| Example 6 | Yes | 1.5 | 42% |
| Example 7 | Yes | 1.4 | 46% |
| Example 8 | Yes | 1.4 | 44% |
| Example 9 | Yes | 1.5 | 43% |
| Example 10 | Yes | 1.4 | 45% |
| Example 11 | Yes | 1.6 | 45% |
| Example 12 | Yes | 1.4 | 45% |
| Example 13 | Yes | 1.4 | 43% |
| Example 14 | Yes | 1.4 | 44% |
| Example 15 | Yes | 1.5 | 42% |
| Example 16 | Yes | 1.5 | 45% |
| Example 17 | Yes | 1.5 | 43% |
| Example 18 | Yes | 1.4 | 45% |
| Example 19 | Yes | 1.4 | 44% |
| Example 20 | Yes | 1.3 | 46% |
| Example 21 | Yes | 1.3 | 46% |
| Example 22 | Yes | 1.3 | 46% |
| Comparative Example 1 | No | / | 68% |
| Comparative Example 2 | Yes | 0.8 | 51% |
| Comparative Example 3 | Yes | 0.9 | 49% |
| Comparative Example 4 | Yes | 0.7 | 53% |
| Comparative Example 5 | Yes | 1.1 | 51% |
| Comparative Example 6 | Yes | 0.7 | 55% |
| Comparative Example 7 | Yes | 1.1 | 48% |

From the above experimental data, it can be seen that the remanence, coercivity, high-temperature stability, magnetic energy product and squareness of the magnet materials prepared according to the formula for R-T-B magnet designed by the inventors are all at a relatively high level, and its comprehensive magnetic properties are excellent, which are suitable for applications in areas with high demands. After further analysis of the microstructure, the inventors found that after the R-T-B magnets with the above specific formula as magnet materials were prepared, a Cu₅Nb₁Fe₉₄ phase with a specific area ratio was formed in the intergranular triangular region of the magnets. The existence of this phase gathers the Fe elements distributed in the two-grain boundary phase, thereby reducing the Fe distributed in the two-grain boundary phase, enhancing the magnetic isolation effect of the Nd-rich phase, and further improving the magnetic properties.

If the content of a certain element in the formula of the R-T-B magnet is not within the scope of the present invention, only a small amount of Cu₅Nb₁Fe₉₄ phase was formed, and it is difficult to significantly reduce Fe in the two-grain boundary phase. For example, in Comparative Example 1, the content of Cu was too low, which resulted in Cu being enriched only in the phase interface between the main phase and the grain boundary phase, and the Cu₅Nb₁Fe₉₄ phase could not be formed in the grain boundary phase. For example, in Comparative Example 4, Al+Cu is greater than 0.5 wt %, which leads to excessive Cu entering into the grain boundary phase, reducing the interface stability, and thus reducing the formation of Cu₅Nb₁Fe₉₄ phase. For example, in Comparative Example 5, Nb+Ti is greater than 0.24 wt %, which leads to excessive pinning of high-melting point elements at the grain boundaries, which affects the fluidity of the Nd-rich phase, resulting in a decrease in the content of Cu₅Nb₁Fe₉₄ phase.

1. An R-T-B magnet, comprising the following components of:
≥30.0 wt % of R, said R is a rare earth element;
0.02-0.14 wt % of Nb;
0.2-0.48 wt % of Cu;
≤0.24 wt % of Ti+Nb;
≤0.50 wt % of Al+Cu;
≥0.955 wt % of B; and
58-69 wt % of Fe, wherein
wt % is the mass percentage of respective component in the total mass of all components.

2. The R-T-B magnet according to claim 1, wherein:
the content of R is 30-33 wt %, such as 30 wt %, 30.3 wt % or 30.8 wt %; and/or
the R further comprises Nd;
wherein the content of Nd is 29-31 wt %, such as 29 wt %, 29.4 wt %, 29.7 wt %, 29.9 wt %, 30 wt %, 30.1 wt % or 30.4 wt %, wherein wt % is the mass percentage of Nd in the total mass of all components; and/or
the R further comprises Pr and/or RH, wherein the RH is a heavy rare earth element;
wherein the content of the Pr is 0.3 wt % or less, wherein wt % is the mass percentage of Pr in the total mass of all components;
wherein the RH is Tb;
wherein the content of the RH is 1.4 wt % or less, such as 0.2 wt %, 0.4 wt %, 0.6 wt % or 1 wt %, wherein wt % is the mass percentage of RH in the total mass of all components;
wherein the ratio of the atomic percentage of the RH to the atomic percentage of the R is 0.1 or less.

3. The R-T-B magnet according to claim 1, wherein:
the content of “Ti+Nb” is 0.1-0.24 wt %, such as 0.1 wt %, 0.2 wt %, 0.23 wt % or 0.24 wt %; and/or
the content of Nb is 0.05-0.14 wt %, such as 0.05 wt %, 0.09 wt %, 0.1 wt %, 0.12 wt % or 0.14 wt %; and/or
the content of Ti is 0.24 wt % or less, excluding 0 wt %, such as 0.05 wt %, 0.09 wt %, 0.11 wt %, 0.14 wt % or 0.15 wt %, wherein wt % is the mass percentage of Ti in the total mass of all components; and/or
the content of “Al+Cu” is 0.44 wt % or less, excluding 0 wt %, 0.1-0.44 wt %, such as 0.23 wt %, 0.25 wt %, 0.32 wt %, 0.33 wt %, 0.34 wt % %, 0.43 wt % or 0.44 wt %; and/or
the content of Al is 0.08 wt % or less, excluding 0 wt %, such as 0.02 wt %, 0.03 wt %, 0.04 wt %, 0.05 wt %, 0.06 wt % or 0.08 wt %, wherein wt % is the mass percentage of Al in the total mass of all components; and/or
the content of Cu is 0.2-0.46 wt %, such as 0.2 wt %, 0.3 wt %, 0.39 wt %, 0.4 wt % or 0.46 wt %.

4. The R-T-B magnet according to claim 1, wherein:
the content of B is 0.955-1.15 wt %, such as 0.99 wt %; and/or
the ratio of the atomic percentage of B to the atomic percentage of R in the R-T-B magnet is 0.38 or more; and/or
the content of Fe is 67-69 wt %, such as 67.53 wt %, 67.64 wt %, 67.65 wt %, 67.68 wt %, 67.74 wt %, 68.02 wt %, 68.03 wt %, 68.04 wt %, 68.16 wt %, 68.31 wt %, 68.38 wt %, 68.49 wt %, 68.57 wt % or 68.58 wt %; and/or
the R-T-B magnet further comprises Co, wherein the content of Co is 1 wt % or less, such as 0.8 wt %.

5. The R-T-B magnet according to claim 1, wherein:
the ratio of the content of Fe in a two-grain boundary phase to the total content of all elements in the two-grain boundary phase is 40-46 wt %, such as 42 wt %, 43 wt %, 44 wt %, 45 wt % or 46 wt %; and/or
the R-T-B magnet comprises a Cu—Nb—Fe phase, and the Cu—Nb—Fe phase is located in an intergranular triangular region;
wherein the ratio of the total area of the Cu—Nb—Fe phase to the total area of the intergranular triangular region is 1.3-2%, such as 1.3%, 1.4%, 1.5% or 1.6%;
wherein, in the Cu—Nb—Fe phase, the ratio of Cu, Nb and Fe in atomic percentage is 5:1:94.

6. The R-T-B magnet according to claim 1, wherein:
the R-T-B magnet comprises the following components of: 29.4 wt % of Nd, 0.6 wt % of Tb, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 45 wt %; or
the R-T-B magnet comprises the following components of: 29.4 wt % of Nd, 0.6 wt % of Tb, 0.8 wt % of Co, 0.3 wt % of Cu, 0.03 wt % of Al, 0.05 wt % of Nb, 0.15 wt % of Ti, 0.99 wt % of B and 67.68 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 46 wt %; or
the R-T-B magnet comprises the following components of: 29.4 wt % of Nd, 0.6 wt % of Tb, 0.5 wt % of Co, 0.2 wt % of Cu, 0.05 wt % of Al, 0.05 wt % of Nb, 0.05 wt % of Ti, 0.99 wt % of B and 68.16 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %; or
the R-T-B magnet comprises the following components of: 29.4 wt % of Nd, 0.6 wt % of Tb, 0.6 wt % of Co, 0.4 wt % of Cu, 0.04 wt % of Al, 0.14 wt % of Nb, 0.09 wt % of Ti, 0.99 wt % of B and 67.74 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.6%, and the ratio of the content of Fe in a two-grain boundary phase to the total content of all elements in the two-grain boundary phase is 43 wt %; or
the R-T-B magnet comprises the following components of: 29.4 wt % of Nd, 0.6 wt % of Tb, 0.2 wt % of Cu, 0.03 wt % of Al, 0.05 wt % of Nb, 0.15 wt % of Ti, 0.99 wt % of B and 68.58 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 43 wt %; or
the R-T-B magnet comprises the following components of: Nd 29.4 wt %, 0.6 wt % of Tb, 0.39 wt % of Cu, 0.04 wt % of Al, 0.05 wt % of Nb, 0.15 wt % of Ti, 0.99 wt % of B and 68.38 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 42 wt %; or
the R-T-B magnet comprises the following components of: 29.4 wt % of Nd, 0.6 wt % of Tb, 0.46 wt % of Cu, 0.04 wt % of Al, 0.05 wt % of Nb, 0.15 wt % of Ti, 0.99 wt % of B and 68.31 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 46 wt %; or
the R-T-B magnet comprises the following components of: 29.4 wt % of Nd, 0.6 wt % of Tb, 0.3 wt % of Cu, 0.04 wt % of Al, 0.05 wt % of Nb, 0.05 wt % of Ti, 0.99 wt % of B and 68.57 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 44 wt %; or
the R-T-B magnet comprises the following components of: 29.4 wt % of Nd, 0.6 wt % of Tb, 0.8 wt % of Co, 0.3 wt % of Cu, 0.03 wt % of Al, 0.1 wt % of Nb, 0.14 wt % of Ti, 0.99 wt % of B and 67.64 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 43 wt %; or
the R-T-B magnet comprises the following components of: 29.4 wt % of Nd, 0.6 wt % of Tb, 0.8 wt % of Co, 0.3 wt % of Cu, 0.03 wt % of Al, 0.12 wt % of Nb, 0.11 wt % of Ti, 0.99 wt % of B and 67.65 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %; or
the R-T-B magnet comprises the following components of: 29.7 wt % of Nd, 0.6 wt % of Tb, 0.39 wt % of Cu, 0.04 wt % of Al, 0.1 wt % of Nb, 0.14 wt % of Ti, 0.99 wt % of B and 68.04 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.6%, and the ratio of the content of Fe in a two-grain boundary phase to the total content of all elements in the two-grain boundary phase is 45 wt %; or
the R-T-B magnet comprises the following components of: 30.4 wt % of Nd, 0.4 wt % of Tb, 0.39 wt % of Cu, 0.05 wt % of Al, 0.1 wt % of Nb, 0.14 wt % of Ti, 0.99 wt % of B and 67.53 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %; or
the R-T-B magnet comprises the following components of: 29.9 wt % of Nd, 0.4 wt % of Tb, 0.39 wt % of Cu, 0.06 wt % of Al, 0.1 wt % of Nb, 0.14 wt % of Ti, 0.99 wt % of B and 68.02 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 43 wt %; or
the R-T-B magnet comprises the following components of: 30.1 wt % of Nd, 0.2 wt % of Tb, 0.39 wt % of Cu, 0.05 wt % of Al, 0.09 wt % of Nb, 0.15 wt % of Ti, 0.99 wt % of B and 68.03 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 44 wt %; or
the R-T-B magnet comprises the following components of: 29.4 wt % of Nd, 0.6 wt % of Tb, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 42 wt %; or
the R-T-B magnet comprises the following components of: 29.4 wt % of Nd, 0.6 wt % of Tb, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 45 wt %; or
the R-T-B magnet comprises the following components of: 30 wt % of Nd, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.5%, and the ratio of the content of Fe in a two-grain boundary phase to the total content of all elements in the two-grain boundary phase is 43 wt %; or
the R-T-B magnet comprises the following components of: 29 wt % of Nd, 1 wt % of Tb, 0.3 wt % of Cu, 0.02 wt % of Al, 0.05 wt % of Nb, 0.15 wt % of Ti, 0.99 wt % of B and 68.49 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 45 wt %; or
the R-T-B magnet comprises the following components of: 28.2 wt % of Nd, 0.6 wt % of Tb, 1.2 wt % of Dy, 0.36 wt % of Cu, 0.02 wt % of Al, 0.05 wt % of Nb, 0.15 wt % of Ti, 0.99 wt % of B and 68.43 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.4%, and the ratio of the content of Fe in a two-grain boundary phase to the total content of all elements in the two-grain boundary phase is 44 wt %; or
the R-T-B magnet comprises the following components of: 28.4 wt % of Nd, 0.6 wt % of Tb, 1 wt % of Dy, 0.5 wt % of Co, 0.36 wt % of Cu, 0.02 wt % of Al, 0.05 wt % of Nb, 0.15 wt % of Ti, 0.99 wt % of B and 67.93 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.3%, and the ratio of the content of Fe in a two-grain boundary phase to the total content of all elements in the two-grain boundary phase is 46 wt %; or
the R-T-B magnet comprises the following components of: 28.8 wt % of Nd, 0.6 wt % of Tb, 0.6 wt % of Dy, 0.36 wt % of Cu, 0.02 wt % of Al, 0.05 wt % of Nb, 0.15 wt % of Ti, 0.99 wt % of B and 68.43 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.3%, and the ratio of the content of Fe in a two-grain boundary phase to the total content of all elements in the two-grain boundary phase is 46 wt %; or
the R-T-B magnet comprises the following components of: 28.2 wt % of Nd, 0.7 wt % of Tb, 0.3 wt % of Dy, 0.8 wt % of Co, 0.36 wt % of Cu, 0.02 wt % of Al, 0.05 wt % of Nb, 0.15 wt % of Ti, 0.99 wt % of B and 68.43 wt % of Fe, wherein wt % is the mass percentage of respective component in the total mass of all components; the R-T-B magnet further comprises a Cu₅Nb₁Fe₉₄ phase in an intergranular triangular region thereof, the ratio of the area of the Cu₅Nb₁Fe₉₄ phase to the total area of the intergranular triangular region is 1.3%, and the ratio of the content of Fe in a two-grain boundary phase to the total content of all elements in the two-grain boundary phase is 46 wt %.

7. A preparation method of a R-T-B magnet, comprising the steps of subjecting a raw mixture comprising respective components for the R-T-B magnet according to claim 1 to pulverization and then sintering treatment, wherein the particle size of the powder obtained after the pulverization is 3.9-4.4 μm.

8. The preparation method of the R-T-B magnet according to claim 7, wherein:
the particle size of the powder obtained after the pulverization is 3.9 μm, 4.0 μm, 4.1 μm, 4.2 μm or 4.3 μm; and/or
the pulverization is jet mill pulverization; and/or
the gas atmosphere during the pulverization is a gas atmosphere with an oxidizing gas content of 1000 ppm or less, and the oxidizing gas content refers to the content of oxygen or moisture; and/or
the temperature for the sintering treatment is 1000-1100° C., such as 1080° C.; and/or
the time for the sintering treatment is 4-8h, such as 6h; and/or
the preparation method further comprises the steps of subjecting a raw mixture comprising respective components for the R-T-B magnet to smelting, casting and hydrogen decrepitation in turn before the pulverization;
wherein the vacuum degree for the smelting is, for example, 5×10⁻² Pa;
wherein the temperature for the smelting is, for example, 1550° C. or less;
wherein the process for the casting is, for example, a strip casting process.
wherein the temperature for the casting is 1390-1460° C., such as 1400° C., 1420° C. or 1430° C.;
wherein the alloy sheet obtained after the casting has a thickness of 0.25-0.40 mm, such as 0.29 mm; and/or
the preparation method further comprises a step of magnetic field shaping after the pulverization and before the sintering treatment.

9. The preparation method of the R-T-B magnet according to claim 7 wherein:
the preparation method further comprises an aging treatment after the sintering treatment;
wherein the aging treatment includes a primary aging treatment and a secondary aging treatment;
the temperature for the primary aging treatment is 860-920° C., such as 880° C. or 900° C.;
The time for the primary aging treatment is 2.5-4h, such as 3h;
the temperature for the secondary aging treatment is 460-530° C., such as 490° C., 500° C., 510° C. or 520° C.;
the time for the secondary aging treatment is 2.5-4h, such as 3h;
wherein, when the R-T-B magnet further comprises a heavy rare earth element, the preparation method further comprises grain boundary diffusion after the aging treatment; the temperature for the grain boundary diffusion is 800-900° C., such as 850° C.; the time for the grain boundary diffusion is 5-10h, such as 8h;
the method of adding heavy rare earth elements in the R-T-B magnet comprises the steps of adding 0-80% of heavy rare earth elements during the smelting and adding the remaining heavy rare earth elements during the grain boundary diffusion; for example, when the heavy rare earth elements in the R-T-B magnet are Tb with a content of greater than 0.5 wt %, 40-67% of Tb is added during the smelting, and the rest is added during the grain boundary diffusion; or, for example, when the heavy rare earth elements in the R-T-B magnet are Tb and Dy, the Tb is added during smelting, and the Dy is added during the grain boundary diffusion; or for example, when the heavy rare earth elements in the R-T-B magnet are Tb with a content of less than or equal to 0.5 wt %, or when the heavy rare earth elements in the R-T-B magnet are Dy, the heavy rare earth elements in the R-T-B magnet are added during the grain boundary diffusion.

10. An R-T-B magnet prepared by the preparation method of the R-T-B magnet according to claim 7.

11. The R-T-B magnet according to claim 2, wherein:
the ratio of the content of Fe in a two-grain boundary phase to the total content of all elements in the two-grain boundary phase is 40-46 wt %, such as 42 wt %, 43 wt %, 44 wt %, 45 wt % or 46 wt %; and/or
the R-T-B magnet comprises a Cu—Nb—Fe phase, and the Cu—Nb—Fe phase is located in an intergranular triangular region;
wherein the ratio of the total area of the Cu—Nb—Fe phase to the total area of the intergranular triangular region is preferably 1.3-2%, such as 1.3%, 1.4%, 1.5% or 1.6%;
wherein, in the Cu—Nb—Fe phase, the ratio of Cu, Nb and Fe in atomic percentage is preferably 5:1:94.

12. The R-T-B magnet according to claim 3, wherein:
the ratio of the content of Fe in a two-grain boundary phase to the total content of all elements in the two-grain boundary phase is 40-46 wt %, such as 42 wt %, 43 wt %, 44 wt %, 45 wt % or 46 wt %; and/or
the R-T-B magnet comprises a Cu—Nb—Fe phase, and the Cu—Nb—Fe phase is located in an intergranular triangular region;
wherein the ratio of the total area of the Cu—Nb—Fe phase to the total area of the intergranular triangular region is preferably 1.3-2%, such as 1.3%, 1.4%, 1.5% or 1.6%;
wherein, in the Cu—Nb—Fe phase, the ratio of Cu, Nb and Fe in atomic percentage is preferably 5:1:94.

13. The R-T-B magnet according to claim 4, wherein:
the ratio of the content of Fe in a two-grain boundary phase to the total content of all elements in the two-grain boundary phase is 40-46 wt %, such as 42 wt %, 43 wt %, 44 wt %, 45 wt % or 46 wt %; and/or
the R-T-B magnet comprises a Cu—Nb—Fe phase, and the Cu—Nb—Fe phase is located in an intergranular triangular region;
wherein the ratio of the total area of the Cu—Nb—Fe phase to the total area of the intergranular triangular region is preferably 1.3-2%, such as 1.3%, 1.4%, 1.5% or 1.6%; wherein, in the Cu—Nb—Fe phase, the ratio of Cu, Nb and Fe in atomic percentage is preferably 5:1:94.
